(19) United States
(12) Patent Application Publication
(10) Pub. No.: US 2003/0178950 A1
(43) Pub. Date: Sep. 25, 2003

(54) Circuit for intermittently illuminating light-emitting device

(76) Inventor: Chih-Yuan Hsu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/104,009

(22) Filed: Mar. 25, 2002

(51) Int. Cl. G09G 3/10

(52) U.S. Cl. 315/291; 315/247

(57) ABSTRACT

The present invention provides a circuit for intermittently illuminating a light-emitting device. The present invention comprises a power input terminal coupled to receive electrical power, a light-emitting device; a switch having a first end connected with the power input terminal, and the switch having a second end which provides a switched electrical power to a light-emitting device; a cyclic pulse signal generator generating at least one cyclic pulse signal where a duty cycle and a frequency thereof are adjustably utilized to control the switch. The circuit for intermittently illuminated light-emitting device of the present invention can generate more than one cyclic pulse signal and control more than one switch, a switch can also be controlled by more than one cyclic pulse signals. Besides, those cyclic pulse signals have respective phases, thus, the operation timing of each switches is interlaced.

### BACKGROUND OF THE INVENTION

1. Field of the Invention

This invention generally relates to the field of control circuits for a light-emitting device. More particularly, the present invention relates to a circuit for intermittently illuminating a light-emitting device.

2. Description of the Prior Art

In the present day field of light-emitting devices, the device that is most commonly used for illuminating and projecting is a LED or Laser Diode, etc. The input of electrical power has to be continuously conducted to continue illumination as a common application, but this creates a fast and continuous consumption of the electrical power input. If the electrical power input is replaced with a battery, then the battery capacity and the consumption rate limit the operating time of the device.

If the light-emitting device is being used as an indicator or brightness is not an issue, the present invention provides a circuit to intermittently illuminate the light-emitting device for the purpose of saving power.

### SUMMARY OF THE INVENTION

In accordance with the present invention, a circuit is provided for intermittently illuminating a light-emitting device.

Accordingly, one object of the present invention is to provide a circuit, which provides an adjustable duty cycle and frequency for intermittently illuminating a light-emitting device.

Another object is to provide a circuit, which generates at least one cyclic pulse signal to control the illumination by intermittently illuminating the light-emitting device.

In accordance with the objects mentioned above, the present invention provides a circuit for an intermittently illuminated light-emitting device. The present invention comprises a power input terminal coupled to receive electrical power. A switch having a first end connected with the power input terminal, and the switch having a second end which provides switched electrical power to a light-emitting device; a cyclic pulse signal generator generating at least one cyclic pulse signal where a duty cycle and a frequency thereof are adjustably utilized to control the switch. The adjustable frequency is between 15 Hz to 10 MHz.

Furthermore, the circuit for intermittently illuminating a light-emitting device in the present invention can generate more than one cyclic pulse signal to control more than one switch. A switch can also be controlled by more than one cyclic pulse signals. Besides, the cyclic pulse signals have respective phases, thus, the operation timing of each switch is interlaced.

Therefore, the present invention provides a circuit for intermittently illuminating a light-emitting device by using a cyclic pulse signal to conduct the intermittent input of the electrical power. The frequency of light emitted as a result of the cyclic pulse signal, will remain within the performing range with out interruption, that the naked eye can accept in accordance with the theory of persistence of vision,. When using a battery as the input electrical power source the present invention can be also be used to extend the battery operating life and save power.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 and FIG. 2 illustrate a preferred embodiment of the present invention;

FIG. 3 and FIG. 4 illustrate another preferred embodiment of the present invention.

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

In accordance with the present invention, a circuit for intermittently illuminating a light-emitting device comprises a power input terminal coupled to receive electrical power. A power output terminal coupled to provide electrical power for the light-emitting device; a switch used to connect the power input terminal and the power output terminal; a cyclic pulse signal generator that generates cyclic pulse signals to control the illumination of the light-emitting device for intermittent illumination. Nevertheless, the pulse generator can adjust the duty cycle and frequency of the cyclic pulse signal.

Furthermore, the circuit for intermittently illuminating a light-emitting device of the present invention can generate more than one cyclic pulse signal and control more than one switch, a switch can also be controlled by more than one cyclic pulse signal. Besides, those cyclic pulse signals have out of phases, thus, the operation timing of each switch is interlaced.

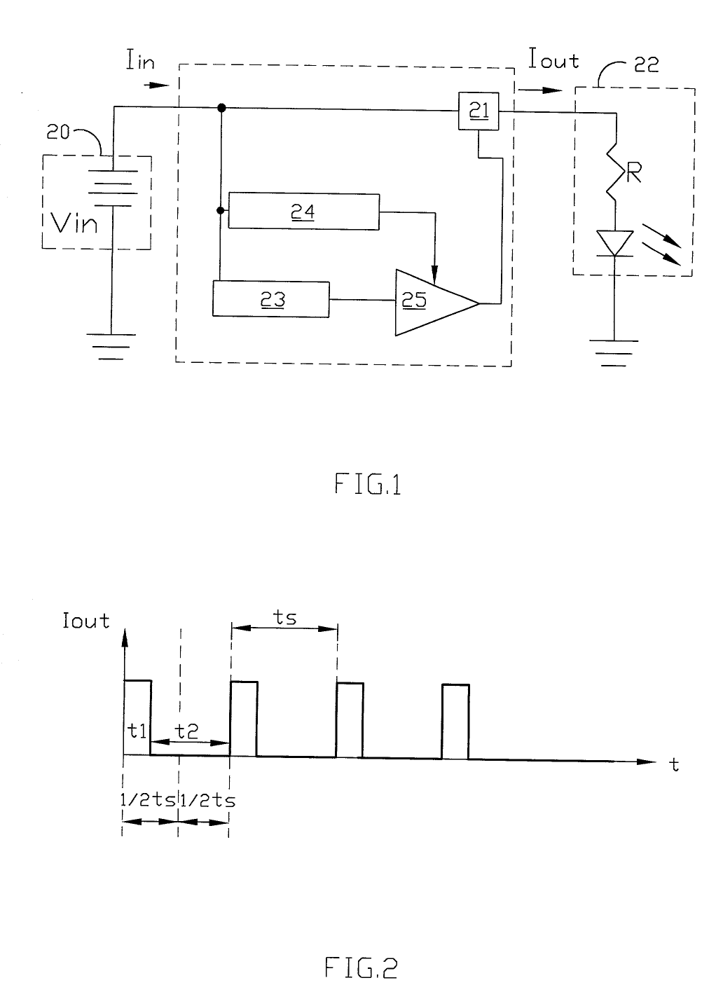

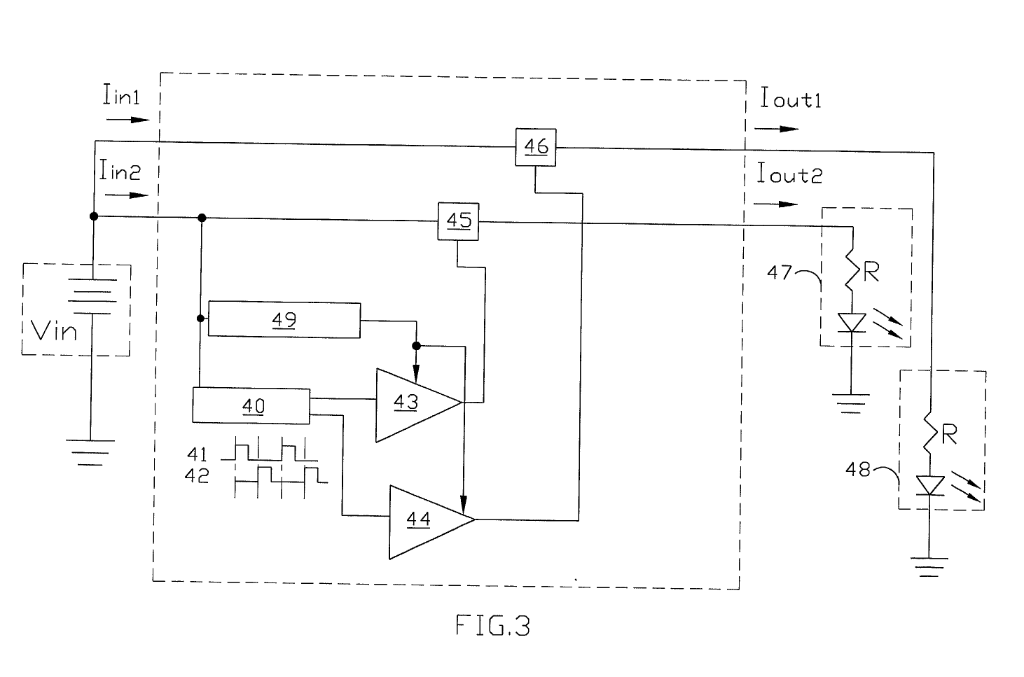

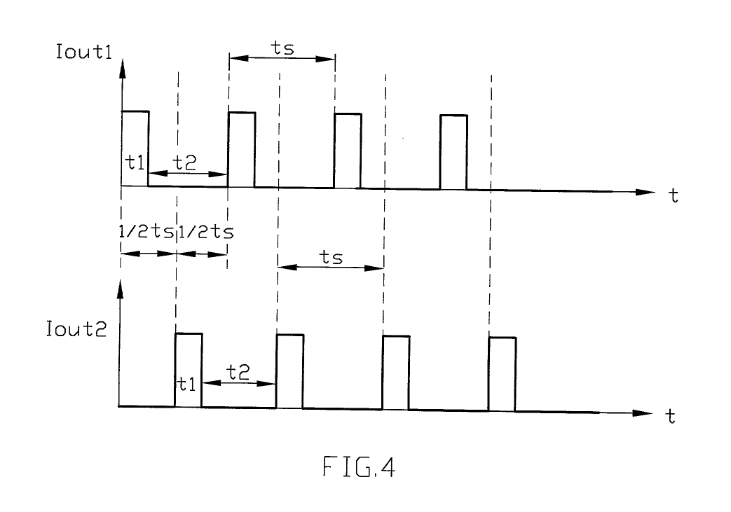

FIG. 1 and FIG. 2 are used to illustrate a preferred embodiment of the present invention, and FIG. 3 and FIG. 4 are used to illustrate another preferred embodiment of the present invention.

Referring to FIG. 1, a switch 21 is used to couple an input power source 20 and a light-emitting device 22. The input power source 20 provides needed power for the light-emitting device 22 to make the light-emitting device 22 illuminate while switch 21 is conducted. However, while switch 21 turns off, the light-emitting device 22 stops illuminating, this is due to an open circuit being generated between the input power source 20 and the light-emitting device 22.

A cyclic pulse signal can operate the turning on and off of switch 21, wherein said switch 21 is a MOSFET (Metal Oxide Semiconductor Field Effect Transistor) switch in this preferred embodiment of the present invention. However, in other embodiments of the present invention, the switch 21 can be of any switch device, which can be operated by at least one cyclic pulse signal.

A cyclic pulse signal generator 23 is used to generate a cyclic pulse signal to operate switch 21, the duty cycle and frequency of the cyclic pulse signal can be adjusted by the cyclic pulse signal generator 23. The adjustable frequency is between 15Hz to 10MHz, wherein said cyclic pulse signal generator 23 is an oscillator in this preferred embodiment of the present invention. However, in other embodiments of the present invention, the cyclic pulse signal generator 23 can be of any device, which can generate the cyclic pulse signal.

Additionally, a charge pump 24 is used to raises the voltage of the input power source 20 to provide needed power for driver 25. The cyclic pulse signal from the cyclic pulse signal generator 23 must first amplify then drive switch 21.

Nevertheless, if a P-channel MOSFET replaces switch 21, then a charge pump 24 and driver 25 as mentioned above are both unnecessary and can be removed. Because the cyclic pulse signal that's generated by the pulse generator 23 can drive the P-channel MOSFET directly.

As shown in FIG. 2, switch 21 is conducted due to thereupon the cyclic pulse signal is in high potential during the period of t1, but on the contrary, switch 21 will be turned off when the cyclic pulse signal turns to low potential during the period of t2. Therefore, the light-emitting device 22 is illuminating intermittently due to the switch being turned on and off alternately. By controlling the duty cycle and frequency it is possible to, on one hand adjust the brightness and interval, and on the other hand decrease needed power. Besides, if the illuminating frequency of the light-emitting device were higher than the effect of persistence of vision, the user wouldn't sense the intermittence, and would consider the light-emitting device 22 illuminated unremittingly.

FIG. 3 and FIG. 4 illustrate another preferred embodiment of the present invention. As shown in FIG. 3, a oscillator 40 generates a first cyclic pulse signal 41 and a second cyclic pulse signal 42 to input to a first driver 43 and a second driver 44 respectively, and used to individually control a first switch 45 and a second switch 46. Further, a charge pump 49 is used to raise the voltage of the input power source to provide needed power for the first driver 43 and the second driver 44.

Besides, if a P-channel MOSFET replaces the first switch 45 and the second switch 46, then the charge pump 49, the first driver 43 and the second driver 44 as mentioned above are unnecessary and can be removed. This is possible because the cyclic pulse signal that's generated by the oscillator can drive such P-channel MOSFET directly.

As shown in FIG. 4, there is a 180-degree phase difference between the first cyclic pulse signal and the second cyclic pulse signal. According to the 180-degree phase difference, after the first cyclic pulse signal 41 stays in a high potential state, the high potential state of the second cyclic pulse signal 42 will occur before the first cyclic pulse signal 41 is in a high potential state again, thus, the high potential stats of both cyclic pulse signals will occur alternately. Consequently, the first light-emitting device 47 and the second light-emitting device 48 will illuminate alternately.

Besides, due to the alternate illumination of the first light-emitting device 47 and the second light-emitting device 48, the user wouldn't sense the intermittence because the lower illuminating frequency remained within the performing range in accordance with the theory of persistence of vision.

Although specific embodiments have been illustrated and described, it will be obvious to those skilled in the art that various modifications may be made without departing from what is intended to be limited solely by the appended claims.

What is claimed is:

1. A circuit for light-emitting device illuminating intermittently with the characteristic of low power consumption, and wouldn't sense the intermittence while illuminating intermittently, said circuit comprising:
a power input terminal coupled to receive a input voltage;
a light-emitting device;
a switch having a first end connected with said power input terminal, said switch having a second end which provides a switched DC voltage to said light-emitting device; and
a cyclic pulse signal generator generating at least one cyclic pulse signal where a duty cycle and a frequency thereof are adjustably utilized to control the switch, and said frequency is between 15 Hz to 10 MHz.

2. The circuit according to claim 1, wherein said at least one cyclic pulse signal comprises a plurality pulse signals having different phase respectively.

3. The circuit according to claim 2, wherein said cyclic pulse signal generator is an oscillator.

4. The circuit according to claim 3, further comprising a driver for receiving and amplifying said cyclic pulse signal to drive said switch.

5. The circuit according to claim 4, wherein said switch is a N-MOSFET switch.

6. The circuit according to claim 3, wherein said switch is a P-MOSFET switch.

7. A circuit for light-emitting device illuminating intermittently with the characteristic of low power consumption, and wouldn't sense the intermittence while illuminating intermittently, said circuit comprising:
a power input terminal coupled to receive a input voltage;
a plurality of light-emitting devices;
a plurality of switches having a first end connected with said power input terminal, said switches having a second end which provide a switched voltage to said light-emitting devices; and
a cyclic pulse signal generator generating at least one cyclic pulse signal where a duty cycle and a frequency thereof are adjustably utilized to control the switches, and said frequency is between 15 Hz to 10 MHz.

8. The circuit according to claim 7, wherein said cyclic pulse signal generator is an oscillator.

9. The circuit according to claim 8, further comprising a plurality of drivers for receiving and amplifying said cyclic pulse signal to drive said a plurality of switches.

10. The circuit according to claim 9, wherein each of said switches is N-MOSFET switch.

11. The circuit according to claim 8, wherein each of said switches is P-MOSFET switch.

12. A circuit for light-emitting device illuminating intermittently with the characteristic of low power consumption, and wouldn't sense the intermittence while illuminating intermittently, said circuit comprising:
a power input terminal coupled to receive a input voltage;
a light-emitting device;
a transistor-switch having a first end connected with said power input terminal, said switch having a second end which provides a switched voltage to said light-emitting device; and
a oscillator generating at least one cyclic pulse signal where a duty cycle and a frequency thereof are adjustable utilized to control the transistor-switch, and said frequency is between 15 Hz to 10 MHz.

13. The circuit according to claim 12, further comprising a driver for receiving and amplifying said cyclic pulse signal to drive said transistor-switch.
